(19) United States
(12) Patent Application Publication
(10) Pub. No.: US 2026/0289336 A1
(43) Pub. Date: Sep. 24, 2026

(54) APPARATUSES AND METHODS FOR MACHINE LEARNING MODEL RELIABILITY ASSESSMENT

(71) Applicant: NOKIA TECHNOLOGIES OY, Espoo (FI)

(72) Inventors: Jian SONG, Palaiseau (FR); Hans Thomas HÖHNE, Helsinki (FI); Afef FEKI, Sceaux (FR); Ahmad MASRI, Tampere (FI); Sakira HASSAN, Espoo (FI)

(21) Appl. No.: 19/469,980

(22) PCT Filed: Feb. 27, 2024
(86) PCT No.: PCT/EP2024/054915

§ 371 Date: Sep. 26, 2025

(30) Foreign Application Priority Data
Mar. 31, 2023 (FI) 20235372

(51) Int. Cl. G06N 5/022

(52) U.S. Cl. CPC G06N 5/022

(57) ABSTRACT

Example embodiments enable reliability assessment of a machine learning model for mobility management related predictions. A client node may be configured to obtain configuration information for reliability assessment of a machine learning model, the configuration information comprising one or more parameters for configuration of an evaluation window, one or more evaluation functions and one or more reliability acceptance thresholds; obtain verification data based on the evaluation window and evaluation criteria for determining at least one reliability measure; determine at least one reliability measure based on the verification data and the one or more evaluation functions; determine qualification of the machine learning model based on the at least one reliability measure and the one or more reliability acceptance thresholds; send a result of the qualification to the network node; receive feedback from the network node based on the result indicating if the client node is authorized to use the machine learning model; and perform a mobility management related prediction based on the machine learning model when authorized by the network node. Apparatuses and methods are disclosed.

### TECHNICAL FIELD

The present application generally relates to wireless technologies. Some example embodiments of the present application relate to reliability assessment of a machine learning model.

### BACKGROUND

In wireless systems, mobility management may be used to ensure service-continuity during mobility of user devices. However, there is a need for improvements in mobility management related decision-making.

### SUMMARY

This summary is provided to introduce a selection of concepts in a simplified form that are further described below in the detailed description.

This summary is not intended to identify key features or essential features of the claimed subject matter, nor is it intended to be used to limit the scope of the claimed subject matter.

Example embodiments may enable determining reliability of a machine learning model used, for example, in mobility management related decision-making prior to performing predictions based on the machine learning model for the decisions. This may be achieved by the features of the independent claims. Further implementation forms are provided in the dependent claims, the description, and the drawings.

According to a first aspect, a client node may comprise at least one processor; and at least one memory including instructions which, when executed by the at least one processor, cause the client node at least to obtain configuration information for reliability assessment of a machine learning model, the configuration information comprising one or more parameters for configuration of an evaluation window, one or more evaluation functions and one or more reliability acceptance thresholds associated with the one or more evaluation functions; obtain verification data within the evaluation window to determine at least one reliability measure for predictions performed with the machine learning model; generate the at least one reliability measure based on the verification data and the one or more evaluation functions; determine qualification of the machine learning model based on the at least one reliability measure and the one or more reliability acceptance thresholds; send a result of the qualification to a network node; receive feedback from the network node indicating if the client node is authorized to use the machine learning model based on the result; and perform a prediction based on the machine learning model when authorized by the network node.

According to an example embodiment of the first aspect, the one or more parameters comprise at least one of a start time of the evaluation window, an end time of the evaluation window, a duration of the evaluation window or an indication of a trigger configured to start the evaluation window.

According to an example embodiment of the first aspect, the trigger comprises at least one of a change in measurement related to radio environment of the client node, a change in mobility profile of the client node, a handover and mobility related event trigger, a geo-location of the client node, or a periodic trigger detected by the client node or indicated by the network node.

According to an example embodiment of the first aspect, the result sent to the network node is indicated with bit information, wherein one bit is used to indicate respective qualification result of comparison of the at least one reliability measure and associated reliability acceptance threshold.

According to an example embodiment of the first aspect, the verification data comprises at least one of ground truth labels or confidence values.

According to an example embodiment of the first aspect, the one or more evaluation functions are configured for calculation at least one of prediction accuracy, mean square error, mean squared logarithmic error, mean absolute percentage error, mean confidence value, negative log likelihood or expected calibration error.

According to an example embodiment of the first aspect, the feedback further comprises instructions to at least one of request for machine learning model update, discard the machine learning model for predicting measurements to be reported, perform the measurements to be reported with a non-machine learning based method, or perform re-assessment of the reliability.

According to an example embodiment of the first aspect, the at least one memory comprises instructions which, when executed by the at least one processor, cause the client node to cause historical data of operations to be stored at the client node or the network node with an indication of a higher reliability measure when performed after use of the machine learning model is authorized and with an indication of a lower reliability measure when performed after use of the machine learning model is not authorized; and perform re-training of the machine learning model based on the historical data stored at the client node or receive an update of the machine learning model re-trained based on the historical data stored at the network node.

According to a second aspect, a network node may comprise at least one processor; and at least one memory including computer program code; the at least one memory and the computer code configured to, with the at least one processor, cause the apparatus at least to exchange configuration information with a client node for reliability assessment of one or more machine learning models, the configuration information comprising at least one of a list of the one or more machine learning models, one or more parameters for configuration of an evaluation window, one or more evaluation functions and one or more reliability acceptance thresholds associated with the one or more evaluation functions; enable the list of machine learning models for reliability assessment; obtain verification data within the evaluation window to determine at least one reliability measure for predictions performed with the one or more machine learning models; determine the at least one respective reliability measure for the one or more machine learning models based on the verification data and the one or more evaluation functions; determine qualification of the one or more machine learning models based on the at least one respective reliability measure and the one or more reliability acceptance thresholds; and send feedback to the client node indicating if the client node is authorized to use one of the machine learning models for prediction based on a result of the qualification.

According to an example embodiment of the second aspect, the at least one memory further comprises instructions which, when executed by the at least one processor, cause the network node to send a request for the verification data within the evaluation window to the client node; and receive the verification data from the client node.

According to an example embodiment of the second aspect, the one or more parameters comprise at least one of a start time of the evaluation window, an end time of the evaluation window, a duration of the evaluation window or an indication of a trigger to start the evaluation window.

According to an example embodiment of the second aspect, the trigger comprises at least one of a change in measurement related to radio environment of the client node, a change in mobility profile of the client node, a handover and mobility related event trigger, a geo-location of the client node, or a periodic trigger detected by the client node or indicated by the network node.

According to an example embodiment of the second aspect, the one or more evaluation functions are configured for calculation of at least one of prediction accuracy, mean square error, mean squared logarithmic error, mean absolute percentage error, mean confidence value, negative log likelihood or expected calibration error.

According to an example embodiment of the second aspect, the feedback further comprises an identifier of the machine learning model authorized for performing measurements to be reported, instructions for repeating the reliability assessment, instructions for performing the measurements to be reported with a non-machine learning based method or instructions to request for a machine learning model update.

According to an example embodiment of the second aspect, the at least one memory comprises instructions which, when executed by the at least one processor, cause the network node to store historical data of operations performed by the client node with an indication of a higher reliability measure when performed after use of the machine learning model is authorized and with an indication of a lower reliability measure when performed after use of a machine learning model is not authorized; and perform re-training of the one or more machine learning models based on the stored historical data.

According to a third aspect, a method carried out by a client node may comprise requesting, from a network node, configuration information for reliability assessment of a machine learning model, the configuration information comprising one or more parameters for configuration of an evaluation window, one or more evaluation functions and one or more reliability acceptance thresholds associated with the one or more evaluation functions; receiving the the network node; configuration information from obtaining verification data within the evaluation window to determine at least one reliability measure for predictions performed with the machine learning model; determining the at least one reliability measure based on the verification data and the one or more evaluation functions; determining qualification of the machine learning model based on the at least one reliability measure and the one or more reliability acceptance thresholds; sending a result of the qualification to the network node; receiving feedback from the network node indicating if the client node is authorized to use the machine learning model based on the result; and performing a prediction based on the machine learning model when authorized by the network node.

According to an example embodiment of the third aspect, the one or more parameters comprise at least one of a start time of the evaluation window, an end time of the evaluation window, a duration of the evaluation window or an indication of a trigger configured to start the evaluation window.

According to an example embodiment of the third aspect, the trigger comprises at least one of a change in measurement related to radio environment of the client node, a change in mobility profile of the client node, a handover and mobility related event trigger, a geo-location of the client node, or a periodic trigger detected by the client node or indicated by the network node.

According to an example embodiment of the third aspect, the verification data comprises at least one of ground truth labels or confidence values.

According to an example embodiment of the third aspect, the one or more evaluation functions are configured for calculation of at least one of prediction accuracy, mean square error, mean squared logarithmic error, mean absolute percentage error, mean confidence value, negative log likelihood or expected calibration error.

According to an example embodiment of the third aspect, the feedback further comprises instructions to at least one of request for machine learning model update, discard the machine learning model for predicting measurements to be reported, perform the measurements to be reported with a non-machine learning based method, or perform re-assessment of the reliability.

According to an example embodiment of the third aspect, the method may comprise causing historical data of operations to be stored at the client node or the network node with an indication of a higher reliability measure when performed after use of the machine learning model is authorized and with an indication of a lower reliability measure when performed after use of machine learning model is not authorized; and performing re-training of the machine learning model based on the historical data stored at the client node or receive an update of the machine learning model re-trained based on the historical data stored at the network node.

According to a fourth aspect, a method carried out by a network node may comprise exchanging configuration n information with a client node for reliability assessment of one or more machine learning models, the configuration information comprising at least one of a list of the one or more machine learning models, one or more parameters for configuration of an evaluation window, one or more evaluation functions and one or more reliability acceptance thresholds associated with the one or more evaluation functions; enabling the list of machine learning models for reliability assessment; obtaining verification data to determine at least one reliability measure for predictions performed with the one or more machine learning models; determining the at least one respective reliability measure for the one or more machine learning models based on the one or more evaluation functions; determining qualification of the one or more machine learning models based on the at least one respective reliability measure and the one or more reliability acceptance thresholds; and sending feedback to the client node indicating if the client node is authorized to use one of the machine learning models for prediction based on a result of the qualification.

According to an example embodiment of the fourth aspect, the method may comprise sending a request for the verification data within the evaluation window to the client node; and receiving the verification data from the client node.

According to an example embodiment of the fourth aspect, the one or more parameters comprise at least one of a start time of the evaluation window, an end time of the evaluation window, a duration of the evaluation window or an indication of a trigger to start the evaluation window.

According to an example embodiment of the fourth aspect, the trigger comprises at least one of a change in measurement related to radio environment of the client node, a change in mobility profile of the client node, a handover and mobility related event trigger, a geo-location of the client node, or a periodic trigger detected by the client node or indicated by the network node.

According to an example embodiment of the fourth aspect, the one or more evaluation functions are configured for calculation of at least one of prediction accuracy, mean square error, mean squared logarithmic error, mean absolute percentage error, mean confidence value, negative log likelihood or expected calibration error.

According to an example embodiment of the fourth aspect, the feedback further comprises an identifier of the machine learning model authorized for performing measurements to be reported, instructions for repeating the reliability assessment, instructions for performing the measurements to be reported with a non-machine learning based method or instructions to request for a machine learning model update.

According to an example embodiment of the fourth aspect, the method may comprise storing historical data of operations performed by the client node with an indication of a higher reliability measure when performed after use of the machine learning model is authorized and with an indication of a lower reliability measure when performed after use of a machine learning model is not authorized; and perform re-training of the one or more machine learning models based on the stored historical data.

According to a fifth aspect, a computer program may be configured, when executed by a processor, to cause an apparatus at least to perform the following: obtain configuration information for reliability assessment of a machine learning model, the configuration information comprising one or more parameters for configuration of an evaluation window, one or more evaluation functions and one or more reliability acceptance thresholds associated with the one or more evaluation functions; obtain verification data within the evaluation window to determine at least one reliability measure for predictions performed with the machine learning model; generate the at least one reliability measure based on the verification data and the one or more evaluation functions; determine qualification of the machine learning model based on the at least one reliability measure and the one or more reliability acceptance thresholds; send a result of the qualification to a network node; receive feedback from the network node indicating if the client node is authorized to use the machine learning model based on the result; and perform a prediction based on the machine learning model when authorized by the network node. The computer program may further comprise instructions for causing the apparatus to perform any example embodiment of the method of the third aspect.

According to a sixth aspect, an apparatus may comprise means for receiving the configuration information from the network node; obtaining verification data within the evaluation window to determine at least one reliability measure for predictions performed with the machine learning model; determining the at least one reliability measure based on the verification data and the one or more evaluation functions; determining qualification of the machine learning model based on the at least one reliability measure and the one or more reliability acceptance thresholds; sending a result of the qualification to the network node; receiving feedback from the network node indicating if the client node is authorized to use the machine learning model based on the result; and performing a prediction based on the machine learning model when authorized by the network node. The apparatus may further comprise means for performing any example embodiment of the method of the third aspect.

According to a seventh aspect, a computer program may comprise instructions for causing an apparatus to perform at least the following: exchange configuration information with a client node for reliability assessment of one or more machine learning models, the configuration information comprising at least one of a list of the one or more machine learning models, one or more parameters for configuration of an evaluation window, one or more evaluation functions and one or more reliability acceptance thresholds associated with the one or more evaluation functions; enable the list of machine learning models for reliability assessment; obtain verification data within the evaluation window to determine at least one reliability measure for predictions performed with the one or more machine learning models; determine the at least one respective reliability measure for the one or more machine learning models based on the verification data and the one or more evaluation functions; determine qualification of the one or more machine learning models based on the at least one respective reliability measure and the one or more reliability acceptance thresholds; and send feedback to the client node indicating if the client node is authorized to use one of the machine learning models for prediction based on a result of the qualification. The computer program may further comprise instructions for causing the apparatus to perform any example embodiment of the method of the fourth aspect.

According to an eighth aspect, an apparatus may comprise means for exchanging configuration information with a client node for reliability assessment of one or more machine learning models, the configuration information comprising at least one of a list of the one or more machine learning models, one or more parameters for configuration of an evaluation window, one or more evaluation functions and one or more reliability acceptance thresholds associated with the one or more evaluation functions; enabling the list of machine learning models 1 for reliability assessment; obtain verification data to determine at least one reliability measure for predictions performed with the one or more machine learning models; determining the at least one respective reliability measure for the one or more machine learning models based on the one or more evaluation functions; determining qualification of the one or more machine learning models based on the at least one respective reliability measure and the one or more reliability acceptance thresholds; and sending feedback to the client node indicating if the client node is authorized to use one of the machine learning models for prediction based on a result of the qualification. The apparatus may further comprise means for performing any example embodiment of the method of the fourth aspect.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to explain the example embodiments. In the drawings:

FIG. 1 illustrates an example of a communication network comprising network nodes and a client node according to an example embodiment.

FIG. 2 illustrates an example of an apparatus configured to practice one or more example embodiments;

FIG. 3 illustrates an example of a neural network model for softmax regression, according to an example embodiment;

FIG. 4 illustrates an example flow chart for reliability assessment of a machine learning model for mobility management predictions, according to an example embodiment;

FIG. 5 illustrates an example of an evaluation window for reliability assessment of predictions within a prediction window, according to an example embodiment;

FIG. 6 illustrates an example flowchart for applying an evaluation window to trigger machine learning model training, according to an example embodiment;

FIG. 7 illustrates an example of a message sequence chart for reliability assessment of a machine learning model by a client node, according to an example embodiment;

FIG. 8 illustrates an example of a message sequence chart for reliability assessment of one or more machine learning models by a network node, according to an example embodiment;

FIG. 9 illustrates an example of a machine learning model for window prediction, according to an example embodiment;

FIG. 10 illustrates an example of a timeline for input data collection, reliability assessment and window prediction, according to an example embodiment;

FIG. 11 illustrates an example of a machine learning model reliability assessment and window prediction procedure, according to an example embodiment;

FIG. 12 illustrates an example of a predictive mobility management, according to an example embodiment;

FIG. 13 illustrates an example of a method carried out by a client node for reliability assessment of a machine learning model, according to an example embodiment; and

FIG. 14 illustrates an example of a method carried out by a network node for reliability assessment of a machine learning model, according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present examples may be constructed or utilized. The description sets forth the functions of the example and a possible sequence of operations for constructing and operating the example. However, the same or equivalent functions and sequences may be accomplished by different examples.

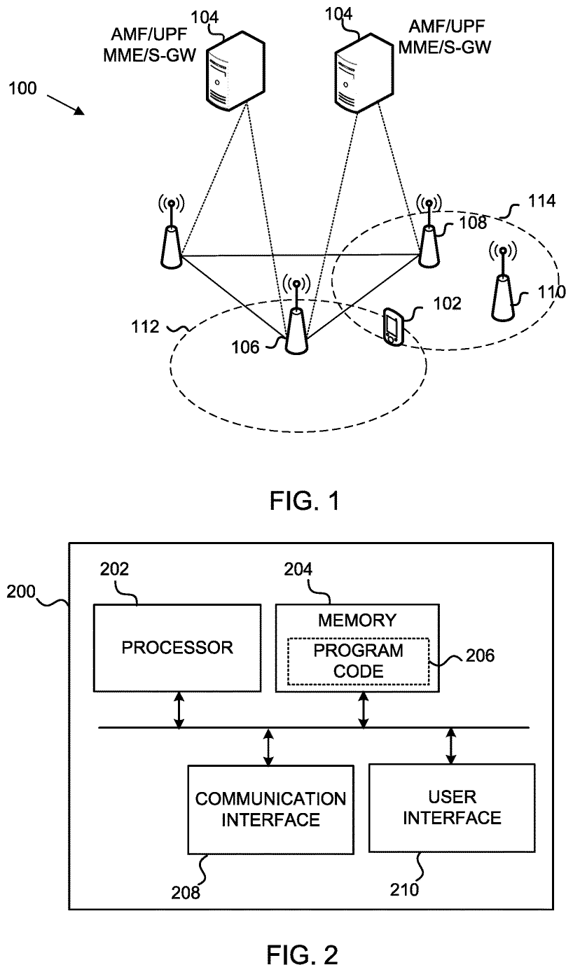

FIG. 1 illustrates an example embodiment of a network 100. The network 100 may comprise one or more core network elements 104. The core network elements may for example comprise one or more access and mobility management Functions (AMF) and/or user plane functions (UPF), for example in accordance with the 3GPP 5G-NR (3rd Generation Partnership Project 5G New Radio) standard. Alternatively, or additionally, the core network elements 104 may comprise one or more mobility management entities (MME) and/or serving gateways (S-GW), for example in accordance with the 3GPP LTE (Long Term Evolution) standard. Network 100 may further comprise at least one client node, which may be also referred to as a user node or user equipment (UE) 102. UE 102 may communicate with one or more base stations 106 over wireless radio channel(s). Base stations may be also called radio access network (RAN) nodes. In general, a base station may comprise any suitable radio access point. For example, the UE 102 may be configured to communicate with a 5G node, gNB, and/or a 4G node, eNB.

Network nodes be may associated with respective coverage areas 112, 114. When the UE 102 moves from coverage area 112 to coverage area 114, the network 100 may be configured to perform handover from a source network node to a target network node, or another prepared target network node.

The network nodes may be configured to communicate with the core network elements 104 over a communication interface, such as for example control plane or user plane interface NG-C/U of the 5G system or an X2 interface of the 4G E-UTRAN (Evolved Universal Terrestrial Radio Access Network). Functionality of a network node may be distributed between a central unit (CU), for example a gNB-CU, and one or more distributed units (DU), for example one or more gNB-DUs. Network elements such as eNB, gNB, gNB-CU, and gNB-DU, AMF, UPF, MME, or S-GW may be generally referred to as network nodes or network devices. Although depicted as a single device, a network node may not be a stand-alone device. Instead, a network node may for example comprise a distributed computing system coupled to a remote radio head. For example, a cloud radio access network (CRAN) may be applied to split control of wireless functions to optimize performance and cost.

Various signaling information may be exchanged in network 100 to provide information related to transmission parameters and allocation of radio resources for data transmission. Signaling information may be provided on various levels of a protocol stack.

FIG. 2 illustrates an example embodiment of an apparatus 200, for example a client node such as UE 102, a network node such as a base station 106. The apparatus 200 may comprise at least one processor 202. The at least one processor may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus may further comprise at least one memory 204. The memory may be configured to store, for example, computer program code or the like, for example operating system software and application software. The memory may comprise one or more volatile memory devices, one or more non-volatile memory devices, and/or a combination thereof. For example, the memory may be embodied as magnetic storage devices (such as hard disk drives, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 200 may further comprise a communication interface 208 configured to enable the apparatus 200 to transmit and/or receive information, for example signaling information or data packets to/from other devices. In one example, the apparatus 200 may use the communication interface 208 to transmit or receive signaling information and data in accordance with at least one cellular communication protocol. The communication interface may be configured to provide at least one wireless radio connection, such as for example a 3GPP mobile broadband connection (e.g. 3G, 4G, 5G). However, the communication interface may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The communication interface 208 may comprise, or be configured to be coupled to, at least one antenna to transmit and/or receive radio frequency signals. One or more of the various types of connections may be also implemented as separate communication interfaces, which may be coupled or configured to be coupled to a plurality of antennas.

The apparatus 200 may further comprise a user interface 210 comprising an input device and/or an output device. The input device may take various forms such a keyboard, a touch screen, or one or more embedded control buttons. The output device may for example comprise a display, a speaker, a vibration motor, or the like.

When the apparatus 200 is configured to implement some functionality, some component and/or components of the apparatus, such as for example the at least one processor and/or the memory, may be configured to implement this functionality. Furthermore, when the at least one processor is configured to implement some functionality, this functionality may be implemented using program code 206 comprised, for example, in the memory 204.

The functionality described herein may be performed, at least in part, by one or more computer program product components such as software components. According to an embodiment, the apparatus comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAS), application-specific Integrated Circuits (ASICS), application-specific Standard Products (ASSPs), System-on-a-chip systems (SOCs), Complex Programmable Logic Devices (CPLDs), Graphics Processing Units (GPUS).

The apparatus 200 may comprise means for performing at least one method described herein. In one example, the means comprises the at least one processor, the at least one memory including program code configured to, when executed by the at least one processor, cause the apparatus 200 to perform the method.

The apparatus 200 may comprise for example a computing device such as for example a base station, a server, a mobile phone, a tablet computer, a laptop, an internet of things (IoT) device, or the like. Examples of IoT devices include, but are not limited to, consumer electronics, wearables, sensors, and smart home appliances. In one example, the apparatus 200 may comprise a vehicle such as for example a car. Although the apparatus 200 is illustrated as a single device it is appreciated that, wherever applicable, functions of the apparatus 200 may be distributed to a plurality of devices, for example to implement example embodiments as a cloud computing service.

Mobility procedures may be enhanced with LTM (Lower layer trigger mobility). In contrast to a higher layer mobility, procedures where a handover between two cells may be decided a RRC (radio resource control) layer, LTM may be performed by the MAC layer terminated in a distributed unit (DU). For example, a LTM may be prepared when a network decides to configure potential target cells for LTM based on a measurement report received from a UE. The network may then send a configuration for LTM to the UE. After a RRC reconfiguration is confirmed by the UE to the network, the UE may start to report periodically L1 beam measurements of serving and candidate target cells. Upon determining there is a target candidate cell having a better radio link beam measurement than the serving cell, e.g., L1-RSRP of target beam measurement is lower than L1-RSRP of serving beam measurement with an offset for, e.g., time-to-trigger (TTT) time, the serving cell may send a MAC control element (MAC CE) or a L1 message to trigger the cell change to the target candidate cell. Thereafter, the handover from the serving cell to the target cell may be executed by the UE.

Radio resource control (RRC) may refer to provision of radio resource related control data. Radio resource control messages may be transmitted on various logical control channels such as for example a common control channel (CCCH) or a dedicated control channel (DCCH). Logical control channels may be mapped to one or more signaling radio bearers (SRBs).

Although some example embodiments have been described using particular RRC messages as examples, it is appreciated that any suitable message(s) may be configured to carry the handover related signaling information described herein. Even though some example embodiments have been described using the 4G and/or 5G networks as examples, it is appreciated that example embodiments presented herein are not limited to these example networks and may be applied in any present or future communication networks, for example other type of cellular networks, short-range wireless networks, broadcast networks, or the like.

A benefit of LTM compared to baseline handover and conditional handover is that the interruption during the handover execution may be reduced as the UE may not need to perform higher layer (RRC, PDCP) reconfiguration and for some scenarios, the UE may perform RACHless to connect the target cell.

Mobility management may be used to ensure service-continuity during the mobility by minimizing call drops, RLFs, unnecessary handovers, and ping-pong handovers, wherein a handover is performed between a cell pair frequently due to movement of a UE. In addition, for applications characterized with a stringent QoS requirements such as reliability or latency, a QoE may be sensitive to the handover performance so that mobility management should avoid unsuccessful handover and reduce the latency during a handover procedure. However, it may be challenging for a trial-and-error scheme to achieve a nearly zero-failure handover. One possible approach to improve mobility performance of UEs is to use artificial intelligence (AI) or machine learning (ML) based solutions. For example, a ML model located at the network may receive as input radio measurements form the UE, predicted resource status of the neighboring radio access nodes and UE trajectory prediction. The inputs may be used to predict the handover target node. The comprise, for example, trajectory prediction may latitude, longitude, altitude, cell ID and beam ID of the UE over a future period of time.

AI or ML based solutions may be used for various use cases. For example, the solutions may be used to provide CSI (channel state information) enhancement such as overhead reduction, improved accuracy and prediction. For another example, the solutions may be used to improve beam management, such as beam prediction in time, and/or spatial domain for overhead and latency reduction, or beam selection accuracy improvement.

In decision-making systems, the decision needs to be accurate. Otherwise, any uncertainty needs to be associated along with the decision. Hence, any ML model, such a deep-learning or statistical model, may need to be both accurate and also indicate how much they are likely to be correct. A ML model may be configured to provide a confidence measure in addition to its prediction. In other words, the probability associated with a predicted class label (in case of a classification problem), should reflect the correctness of the likelihood of its ground truth.

To estimate the expected accuracy of a ML model from finite samples, the predictions may be grouped into M interval bins (each of size 1/M) to calculate the accuracy of each bin. Let Bₘ be the set of indices of samples whose prediction confidence falls into the interval

$${I}_{m} = ( \frac{m - 1}{M} , \frac{m}{M} ] .$$

The accuracy of Bₘ can be defined as

$$acc ( {B}_{m} ) = \frac{1}{\vert {B}_{m} \vert} {\sum }_{i ∈ {B}_{m}} 1 ( {\hat{y}}_{i} = {y}_{i} ) ,$$

where \hat{γ}ᵢ and γᵢ are the predicted and true class labels, respectively, for sample i. Here, 1(x) is an indicator function.

Model confidence may be estimated based on the average confidence within bin Bₘ as

$$conf ( {B}_{m} ) = \frac{1}{\vert {B}_{m} \vert} {\sum }_{i ∈ {B}_{m}} {p}_{i} ,$$

where pᵢ is the confidence score for sample i.

In the above mathematical definition, the model accuracy is defined in a manner that true class labels are needed in order to verify the correctness of prediction. However, the (average) model confidence mainly refers to the average confidence score, represented as a probability distribution, within a certain sample window, where such a score is related to the model design and use cases. For example, a softmax function may be used in classification algorithms where there is a need to obtain probability or probability distribution as the output. This probability may be used as an estimate of confidence value pᵢ and the sofmax function may be used as an activation function in a final layer of the neural network. The output of softmax function can be seen as a probability distribution given the output sums up to 1.

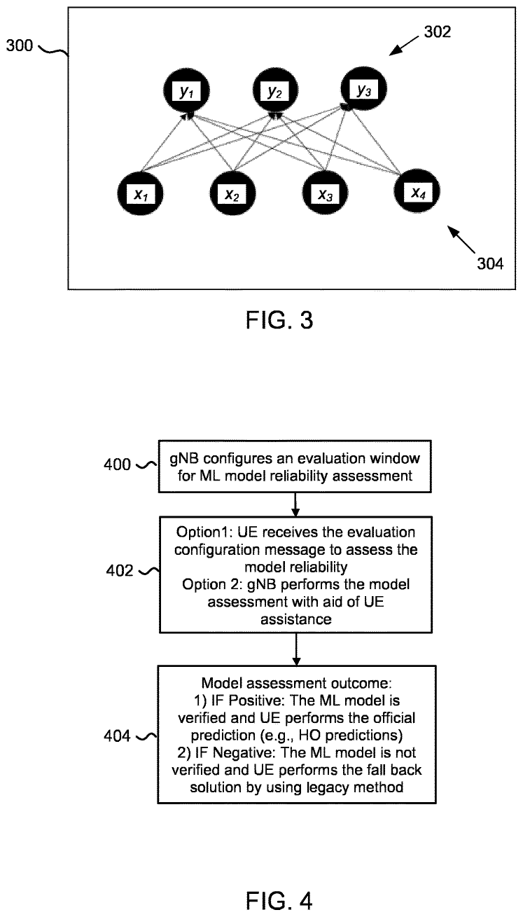

FIG. 3 illustrates an example of a neural network model 300 for softmax regression. The softmax regression may be also referred to as a softmax classifier. The softmax regressor may be represented as a fully-connected single-layer neural network where the single layer comprises three computation units. In FIG. 3, an input layer 304 of the softmax regressor may comprise input values x1, x2, x3, x4 and an output layer 302 of the softmax regressor may comprise output values y1, y2 and y3. The illustrated input and output layers are one example. Output values or probabilities such as p₁, p₂, and p₃ may be calculated using the softmax

$${p}_{i} = \frac{exp ( {y}_{i} )}{{\sum }_{k} exp ( {y}_{k} )} .$$

In addition to a softmax function, pᵢ may be computed using, for example, Brier score or negative log likelihood (NLL).

An objective of this disclosure is to provide a mechanism that may enable a ML model reliability assessment procedure, wherein a prediction window for mobility related use case, such as LTM, in future timelines may be trusted for mobility related decision making.

For ML-aided mobility management, e.g., LTM, a prediction window is introduced that may allow to extract a sequence of predictions of target variables such as beam IDs and associated RSRP values for handover (HO) decision making. With aid of this feature, an additional degree of freedom in terms of robustness is introduced for more flexible and proactive mobility management. However, the following issues may need to be addressed before applying the ML-based functionality.

Firstly, adopting a ML model may offer little benefit if their predictions provide few actionable insights. More precisely, applying poor prediction may lead to inappropriate HO decision, which may further cause degradation in mobility performance.

Secondly, there are various ways of ML model reliability evaluation methodologies available in ML field, such as model confidence score/value, confidence interval, accuracy, etc. However, a design or use of the assessment method should be adapted to the desired use cases.

Thirdly, there has been no detailed mechanisms and signaling configuration available to evaluate the ML model reliability. For example, it should be determined what parameters, e.g., thresholds, to include in the configuration message, whether an evaluation time window/period to assess the defined confidence score is needed, and should retraining be triggered if the model performance, e.g., confidence score is too low.

An example embodiment provides a solution embedded into a process which involves multiple steps, where each of the steps may have multiple solution variants. In this disclosure, a focus is on the aspect of configuring at the UE a ML model assessment mechanism that identifies prediction accuracy and reliability such that viable prediction functionality in the future time window can be performed. An objective of the proposed solution is to determine whether a current situation is suitable to apply machine learning to make predictions and possibility for how long such situation will last. In other words, the UE may need to assess and verify that its ML model is good enough, i.e., able to give predictions within accepted predefined accuracy boundaries, given the current situation (e.g., radio environment, UE speed, etc.) before using ML model for actual decision making (e.g., HO prediction). Moreover, performing the assessment over a window of time may give a good indication that the assessment reliability results will apply also for the upcoming future time window assuming slow moving environment.

According to an example embodiment, a ML model evaluation time window-based mechanism is provided, which is configured to perform model assessment prior to the official prediction phase. An implementation algorithm may be configured to loop including model qualification and/or re-training procedures. In addition, reliability assessment criteria for the ML model may be determined.

According to an example embodiment, signaling configuration for the UE-side ML model reliability evaluation and assessment is provided, comprising a signalling channel to be used, or protocol layer to be used. For example, RRC or MAC may be selected depending on time constrains of the model reliability evaluation execution, data collection, and feedback indication, etc. A configuration message received from a network may include but not limited to the following: 1) evaluation time instances, 2) evaluation window settings, 3) assessment criteria, and other perspectives.

According to an example embodiment, signaling configuration for base station-side model reliability evaluation and assessment is provided, comprising a signalling channel to be used, or protocol layer to be used. For example, RRC or MAC may be selected depending on time constrains of the model reliability evaluation execution, data collection, and feedback indication, etc. A configuration message may include but not limited to the following: 1) evaluation period, 2) window settings, 3) assessment criteria, and other perspectives.

Different from the UE-side model reliability evaluation, in the base station-side assessment the base station may be configured to request the verification data from the UE and the list of candidate ML models can be evaluated simultaneously.

FIG. 4 illustrates a high-level overview of main functionality blocks for a ML based evaluation time window operation. The ML based evaluation time window operation may be utilized for a proper usage of an ML based prediction for mobility management enhancement, such as for L1/L2-Triggered Mobility (LTM).

At 400, a base station, such as a gNB, may be configured to configure an evaluation time window for ML model reliability assessment.

At 402, a UE may be configured to receive a configuration message to assess the ML model reliability from the gNB comprising the evaluation time window. Alternatively, the gNB may be configured to perform the ML model assessment based on assistance from the UE.

At 404, the ML model assessment outcome is determined. If the outcome is positive, the ML model may be verified and the UE may be configured to perform an official prediction, such as HO predictions. If the outcome is negative, the ML model may not be verified and the UE may be configured to perform a fallback solution by using a legacy method.

The evaluation time window or period may be configured to assess the ML model reliability before starting/resuming an inference phase for prediction. The gNB may be configured to authorized whether to start the inference phase based on the ML model assessment outcome of reliability. Therefore, the follow-up prediction may be only granted when the ML model evaluation and assessment passes. Otherwise, the gNB may configure the UE to apply model retraining or update or use legacy policies for decision making.

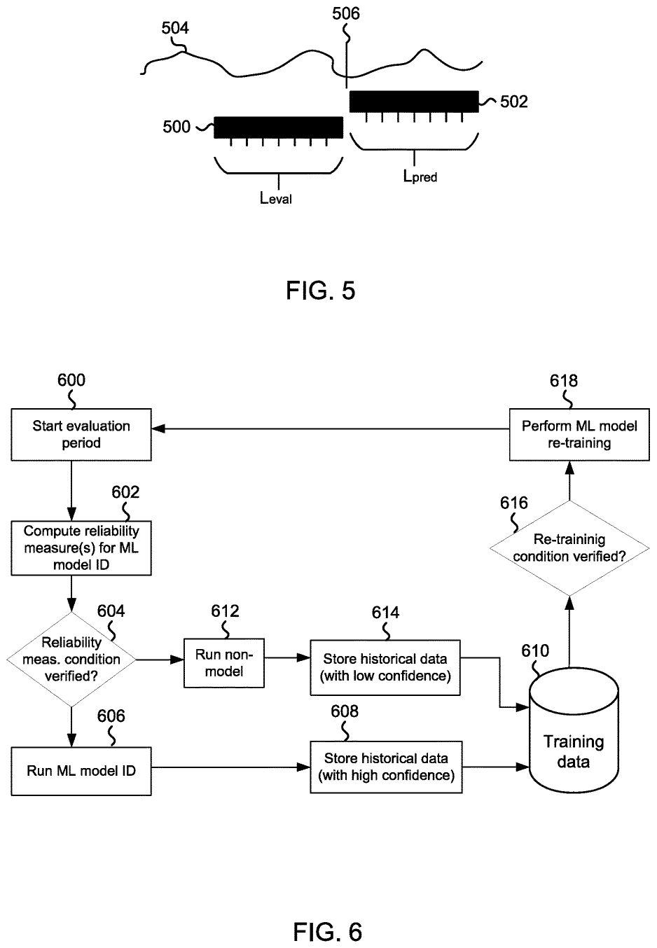

FIG. 5 illustrates an example of evaluation and prediction windows 500, 502 according to an example embodiment. A certain UE may be configured to perform ML model reliability evaluation based on confidence scores which are received from a network side as part of the window assessment configuration. A window may refer to a time period.

For example, a gNB may be configured to determine the ML model evaluation and assessment window for the UE including time instances of a starting point

$${t}_{S}^{eval}$$

and an end point

$${t}_{E}^{eval}$$

of the evaluation window 500. In another implementation, the network may configure the UE to detect some environment changes and based on the detected changes an ML model-based window evaluation will be started.

During the evaluation window 500, ML model predictions may be tested against ground truth by the the UE may be configured to collect UE. Further, reliability measures based on the predictions. For example, a sliding evaluation window 500 with length Lₑᵥₐₗ may be configured for collecting samples of model reliability measure in terms of probability distribution. The prediction window 502 with length L_{pred} may be configured to be triggered once a predefined condition processed during the evaluation window 500 is verified by the UE. This procedure may allow to avoid running ML function if the reliability measure is low. In the example of FIG. 5, the input to the ML model may be displayed, e.g., as a RSRP trace 504. The vertical line in the middle designates t=present time 506. The output of the ML model may be any of predicted RSRP values, or key markers such as, for example, anticipated HO events, within the prediction window 502.

FIG. 6 illustrates an example of a flowchart for applying an evaluation window to trigger ML model training. A selected ML model assessment and evaluation criterion may be based, for example, on a ML model confidence. The ML model may be configured to run at a UE side with network assistance. The UE may not be allowed to directly run the ML model until it receives an approval from the network side.

First, at 602, the UE may be configured to compute a reliability measure as an assessment metric, e.g., the confidence, for one or more specific ML model identities/ID(s) during a pre-selected evaluation window started at 600.

If an assessment condition is verified by the UE, at 604, then the UE may be allowed to run the ML model ID for a targeted inference (e.g., a target beam prediction during mobility) at 606. The actual ML execution may be performed by the UE only when the assessment condition is satisfied. Otherwise, the UE may be configured to perform an estimation of the assessment metric (e.g., confidence) again to check whether to continue to use the ML model or not. At 608, historical data with an indication of a high reliability measure, e.g., high confidence score, may be stored, for example by the network at a database 610, during the operation of the ML model at 606.

If the assessment condition is not verified at 604, it may indicate that the ML performance can be degraded in the current conditions and the UE is not confident enough about the ML model usage. In this case, the UE may be for example configured to revert to a non-ML mode and perform a conventional procedure (e.g., beam/cell selection based on a A3 event) at 612.

Additionally, historical data with an indication of reliability measure, low e.g., low confidence score during the period of non-ML operation may be stored at 614 to the database 610. This can be realized at network side if the ML model training is expected to be performed in the network. At 616, the network may be configured to verify if a re-training condition is met. For example, if the gathered data reaches a targeted size, the network can be configured to perform re-training/refining of the ML model at 618 in order to improve its performance. The goal is to reach a desired confidence level of the ML model substantially all the time and to let the UE keep using the ML for its inference as long as possible.

Without a loss of generality, the following potential options may be used to formulate an evaluation function ƒ_{E} for ML based model reliability assessment. In the following examples, Lₑᵥₐₗ is the evaluation time window length and a dataset within the evaluation time window is Dₑᵥₐₗ.

For example, the evaluation function may be formulated based on prediction accuracy as follows:

$${f}_{E} = \frac{1}{\vert {D}_{eval} \vert} {\sum }_{i ∈ {D}_{eval}} 1 ( {\hat{y}}_{i} = {y}_{i} ) ,$$

where ŷᵢ is the prediction and yᵢ is the ground truth for the i-th sample. 1(·) is an indicator function.

For example, the evaluation function may be formulated based on a mean square error (MSE) as follows:

$${f}_{E} = \frac{1}{\vert {D}_{eval} \vert} {\sum }_{i ∈ {D}_{eval}} {\{ ( {\hat{y}}_{i} = {y}_{i} ) \}}^{2} ,$$

where ŷᵢ is the prediction and yᵢ is the ground truth for the i-th sample.

For example, the evaluation function may be formulated based on a mean squared logarithmic error (MSLE) as follows:

$${f}_{E} = \frac{1}{\vert {D}_{eval} \vert} {\sum }_{i ∈ {D}_{eval}} {\{ log ( 1 + {y}_{i} ) - log ( 1 + {\hat{y}}_{i} ) \}}^{2} ,$$

where ŷᵢ is the prediction and yᵢ is the ground truth for the i-th sample. This metric may be used with targets having an exponential growth.

For example, the evaluation function may be formulated based on a mean absolute percentage error (MAPE) as follows:

$${f}_{E} = \frac{1}{\vert {D}_{eval} \vert} {\sum }_{i ∈ {D}_{eval}} \frac{\vert {\hat{y}}_{i} - {y}_{i} \vert}{max \{ ϵ , \vert {y}_{i} \vert \}} ,$$

where ŷᵢ is the prediction and yᵢ is the ground truth for the i-th sample, and e is an arbitrary small yet strictly positive number to avoid undefined results when yᵢ is zero.

For example, the evaluation function may be formulated based on a (mean) confidence value as follows:

$${f}_{E} = \frac{1}{\vert {D}_{eval} \vert} {\sum }_{i ∈ {D}_{eval}} {p}_{i} ,$$

where pᵢ is the confidence score of the i-th prediction. As an example, an exact probabilistic value for pᵢ can be obtained from the output of a softmax activation function in the output layer.

For example, the evaluation function may be formulated based on a negative log likelihood as follows:

$${f}_{E} = - \frac{1}{\vert {D}_{eval} \vert} {\sum }_{i ∈ {D}_{eval}} log ( {p}_{i} \times Pr ( {\hat{y}}_{i} = {y}_{i} ) ) ,$$

where pᵢ is the confidence score of the i-th prediction. As an example, an exact probabilistic value for pᵢ can be obtained from the output of a softmax activation function in the output layer. Pr(\hat{γ}ᵢ=γᵢ) denotes the model accuracy.

For example, the evaluation function may be formulated based on an expected calibration error (ECE) as follows:

$${f}_{E} = \frac{1}{\vert {D}_{eval} \vert} \vert Pr ( {\hat{y}}_{i} = {y}_{i} ) - {p}_{i} \vert ,$$

where \hat{γ}ᵢ is the prediction and γᵢ is the ground truth for the i-th sample, and pᵢ is the confidence score of the i-th prediction. As an example, an exact probabilistic value for pᵢ can be obtained from the output of a softmax activation function in the output layer.

When the ML model-based prediction is performed at UE, the ground truth and correct labels may be available at the UE side for each prediction \hat{γ}ᵢ. This information can be used for model reliability evaluation when the procedure is executed at the UE side. Otherwise, a gNB may request the UE to send the ground truth related verification data when evaluation is configured to be done at the gNB side.

The evaluation for ML model assessment may be performed in various ways based on the above evaluation function. In general, the evaluation function can be either accuracy-based or error-based. For example, the following examples may be considered for implementation:

The ML model assessment may be based on a positive measure. For example, the gNB/NW may configure a threshold γₜₕ that presents a model reliability acceptance ratio. If ƒ_{E}>γₜₕ, the model assessment phase may be set to be qualified.

Alternatively, the ML model assessment may be based on a negative measure. For example, the gNB/NW may configure a threshold εₜₕ that presents a model reliability acceptance error. If ƒ_{E}<εₜₕ, the model assessment phase may be set to be qualified.

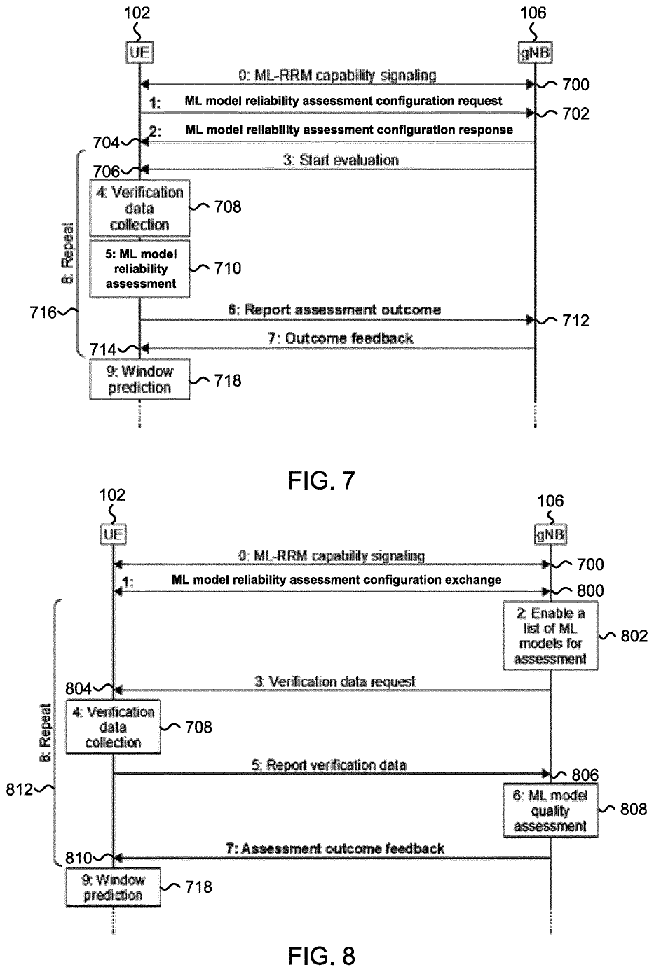

FIG. 7 illustrates an example of a signalling procedure for ML model reliability evaluation and assessment at a UE, according to an example embodiment. The machine learning model may refer to a ML based algorithm.

At 700, capability information and/or configurations between the UE 102 and a base station 106, such as a gNB, may be exchanged for ML-based radio algorithms. For example, the UE 102 may be configured to request the ML-based functionalities to support a target use case, such as LTM.

At 702, the UE 102 may be configured to request one or more signalling configurations from the gNB to be used for execution of one or more ML model(s) reliability assessment. The requested signalling configuration message may comprise, for example, a ML model ID or ML-related algorithm ID. The ID may be optional when the UE 102 is equipped with ML-based functionalities. The signalling configuration message may also comprise one or more parameters an for evaluation window configuration, such as:
Timing instances to start and stop the evaluation time window,

$${t}_{S}^{eval} and {t}_{E}^{eval} ,$$

respectively. Alternatively, the evaluation window can be aligned with use case related triggers and duration, e.g., a L1/L2 reporting period; and/or
A sliding window with a length Lₑᵥₐₗ to collect model assessment samples.

In addition, or alternatively, the signalling configuration message may comprise evaluation and assessment criteria, such as the evaluation function ƒ_{E}. The evaluation may be based on a standalone method or joint evaluation. Upon each assessment criterion, one or more thresholds, namely model reliability acceptance ratios, can be generated from the gNB to the UE 102 for model qualification.

In addition, or alternatively, the signalling configuration message also may comprise other perspectives. The signalling configuration message may comprise, for example, at least one of a signalling channel to be used, or protocol layer to be used, e.g., RRC or MAC selected depending on the time constrains of the model reliability evaluation execution, data collection, and feedback indication, etc.

At 704, the gNB may be configured to send the one or more signalling configurations to be used for the execution of one or more ML model(s) reliability assessment as requested by the UE 102 at 702. The UE 102 may be configured to perform evaluation and assessment periodically when an official prediction phase (at 718) is triggered periodically. For example, the UE may be configured with a timer for initiating the reliability assessment. The UE may also be configured to detect changes in environment to trigger the model reliability assessment procedure before resuming inference. The changes in environment may comprise, for example, changes in measurements due to a change in radio environment, or changes in UE mobility profiles such as in UE speed/trajectory, etc. The changes in radio environment may comprise, for example, a change in radio link quality, a change in cell-edge or cell-center based on coupling gain, or the like. Alternatively, the gNB may be configured to detect one or more of the changes in environment and indicate the UE to perform the evaluation. The UE may be also configured to perform the evaluation based on other triggers, such as handover and mobility related events (A3, TTT, etc.) or geo-locations of the UE.

Configuration information for the reliability assessment may be also received from the gNB without a request from the UE. Alternatively, the configuration information may be preconfigured at the UE and comprised, for example, in UE capability information.

At 706, the gNB may be configured to send an indication message for the UE 102 to trigger a ML model evaluation and assessment phase to start according to the evaluation window.

At 708, the UE 102 may be configured to collect verification data. The verification data may be collected during the configured evaluation and assessment phase with aid of the sliding window as determined at 702 and 704. The verification data can comprise, for example, a ground truth label, which may depend on output samples, such as beam IDs, RSRP values, etc. The ground truth label may be applied to calculate the prediction accuracy. The verification data may also comprise one or more measures for reliability, which may depend on the model architecture and pre-configuration, such as confidence value per prediction sample, etc. The measures may be applied to calculate an average prediction confidence, for example.

At 710, the UE 102 may be configured to perform a ML model assessment procedure. The UE 102 may generate one or more model reliability measures based on the verification data collection and computation of one of more evaluation functions to check an assessment condition. The model reliability measure may be verified against associated reliability acceptance threshold such as model reliability acceptance ratios configured by the gNB.

At 712, the UE 102 may be configured to report the outcome of the model reliability assessment to the gNB. Various options may be applied for indicating the outcome in a message sent to the gNB. For example, the UE 102 may be configured to use:
1 bit information, wherein the UE 102 is configured to send a message 1 or 0 to indicate if the ML model evaluation qualified or failed based on the model reliability measure and model reliability acceptance ratio; or
n-bit information, wherein a generalized n-bit indication is sent by the UE 102 based on a comparison of multiple model reliability measures against model reliability thresholds.

At 714, the gNB may be configured to send outcome feedback to the UE 102 for the following process:
if the outcome feedback indicates a negative acknowledgement (NACK), the gNB may indicate the UE 102 to request for model update/retraining and re-assessment process with the steps and configuration defined at 702 (e.g., via RRC reconfiguration). The gNB may further indicate the UE 102 to discard the present model for follow-up procedure, and to use a legacy policy for decision-making.
if the outcome feedback indicates an acknowledgement (ACK), the current model reliability assessment has passed, and the UE 102 is granted to perform the official prediction phase at 718.

At 716, the UE 102 may be configured to repeat the evaluation loop, starting for example at 702 or 706, according to the outcome feedback received from the gNB at 714.

At 718, the UE 102 may be configured to perform window prediction to output a sequence of interested variables, e.g., beam IDs, cell IDS with L1/L2 measurement estimates, etc. Window prediction refers to performing one or more predictions within a configured prediction window. The signaling mechanism and design guidelines for ML prediction window is out of scope of the present disclosure and are not therefore described herein in detail.

FIG. 8 illustrates an example of a signalling procedure for ML model reliability evaluation and assessment at a base station, according to an example embodiment.

At 700, a UE 102 and the base station 106, such as gNB, may be configured to perform capability exchange for ML-based radio algorithms. For example, the UE may be configured to request the ML-based functionalities to support a target use case, such as LTM.

At 800, the UE and the gNB may be configured to exchange ML model quality assessment configuration for execution of one or more ML model(s) reliability assessment at the gNB side. An agreed configuration signalling message may comprise, for example, a list of candidate ML models or enabled ML-based algorithms for qualification. The configuration signalling message may further comprise parameters related to configuration for an evaluation time window, such as evaluation period and sliding time window settings. The configuration signalling message may also comprise evaluation and assessment criteria, including evaluation methodologies and model reliability acceptance ratios. In addition, the configuration signalling message may comprise a signalling channel to be used, or a protocol layer to be used. For example, RRC or MAC may be configured to be selected depending on time constrains of the model reliability evaluation execution, data collection, and/or feedback indication. The operation 800 is similar to the operations 702 and 704 for UE-side model reliability evaluation and assessment described in FIG. 7.

At 802, the gNB may be configured to enable a list of pre-trained candidate ML models for assessment.

At 804, the gNB may be configured to send a verification data request to the UE 102. At 708, the UE 102 may be configured to prepare and collect the verification data. At 806, the UE 102 may be configured to report the verification data to the g gNB for assessment. The requested verification data may be determined based on the configuration of evaluation window settings and assessment criteria determined at 800. For example, the UE 102 may hold ground truth data samples and if the requested labels are RSRP measurement, then the verification data report may be sent via a L1/L2 interface.

At 808, the gNB may be configured to perform a ML model assessment procedure. The verification data may be collected at 708 during the configured evaluation phase with aid of a sliding window if the ground truth labels are used to calculate the model accuracy. Otherwise, one or more measures for reliability, which may depend on the ML model architecture and pre-configuration, such as confidence value per prediction sample, can also be applied to calculate an average prediction confidence. An assessment condition may be checked similarly as at operation 710 in FIG. 7 for the UE-side model reliability evaluation and assessment. However, when performed at the gNB side, a list of ML models may be evaluated at the operation 808. The gNB may be configured to perform evaluation of the reliability also without requesting verification data from the UE, for example, by using historical data for the verification.

At 810, the gNB may be configured to send an outcome of the assessment at 808 to the UE 102. A ML model ID with the best assessment performance may be granted to the UE for window prediction at 718.

Alternatively, if a majority of the ML models in the candidate list do not provide feasible reliability performance, the gNB may be configured to suggest the UE 102 to repeat an evaluation loop at 812, for example, starting from operation 800.

At t 812, the gNB (and the UE 102) may be configured to repeat the evaluation loop upon the transmission of the outcome feedback to the UE at 810.

At 718, the UE 102 may be configured to perform the window prediction to output a sequence of interested variables, such as cell IDs with L1/L2 measurement estimates, or the like. The signaling mechanism and design guidelines for ML prediction window is out of scope of the present disclosure and are not therefore described herein in detail.

In both signaling diagrams of FIG. 7 and FIG. 8, the evaluation loop may be repeated until the assessment outcome is positive for the UE to perform the ML window prediction. Next, an implementation example is provided that includes the ML model structure, and input and output features for mobility management. The example is focused on the case for UE-side model reliability evaluation and assessment, and it is easily generated to the other case when model assessment is conducted at the gNB side.

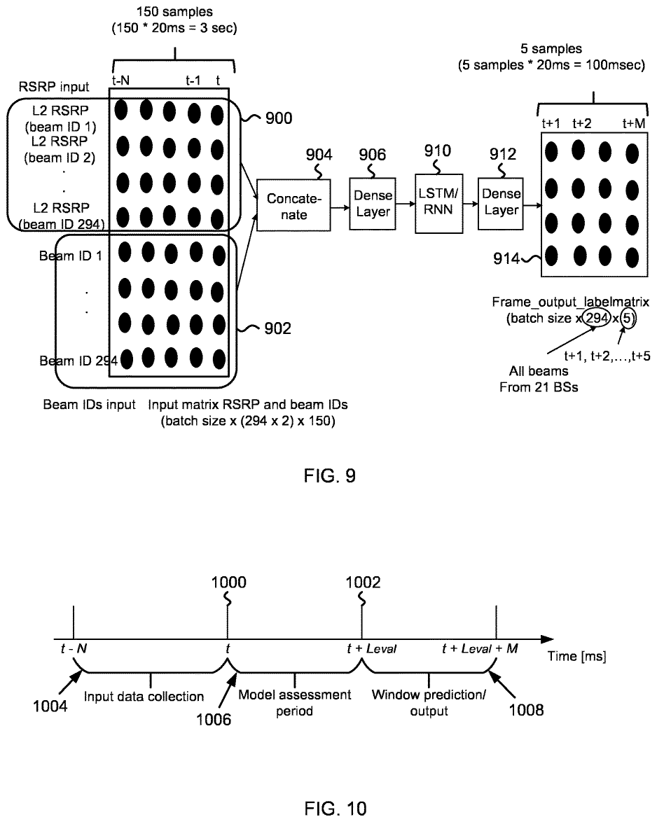

In the following, a ML-based model or algorithm is enabled to perform a sequence/window of output in a future time domain. In FIG. 9, an example model structure is presented, where an input frame can be a sequence of L2-RSRP measurements 900 and/or a sequence of beam IDs 902. Further, the two inputs 900, 902 may be configured to concatenated at operation 904 before feeding into the ML model. Furthermore, the input frame, such as L2-RSRP+Beam IDs 900, 902, may be fed into the ML model, such as a long-short-term-memory (LSTM) recurrent neural network (RNN) 910 to obtain a time sequence output 914. The output of the ML model can be any of predicted L2-RSRP values, or key markers, e.g., HO indicator metric/predicted HO events within the prediction window. The ML model may further comprise one or more dense layers 906, 912 configured to help in changing the dimensionality of the output from the preceding layer so that the ML model can more easily define the relationship between the values of the data in which the ML model is working.

The input sequence at time t may be denoted as (Qₜ₋₁, . . . , Q_{t-N}). Each sample Q may comprise:

$$Q = \{ r , b \} = \{ \{ {r}_{1} , {r}_{2} , … , {r}_{294} \} , \{ {b}_{1} , {b}_{2} , … , {b}_{294} \} \} \} ,$$

where r={r₁, r₂, . . . , r₂₉₄} is the input RSRP vector 900 measured, for example, from 294 beams (beam IDs 902, e.g., 14 beams from 21 gNBs), i.e., b={b₁, b₂, . . . , b₂₉₄}. The input frame may be measured from past N ms that contains q past samples for each measurement or beam ID. In this example, the gNB measures SSB every 20 ms and q=150 measurement samples are collected within the total input length N=3000 ms. Here, the input data is thus a 150×588 matrix.

Thus, the labeled data used to train the ML model may be the sequence of RSRP samples in a given prediction window M ms that contains m past samples for each RSRP measurement or beam ID. In this example, the prediction output is the RSRP measured from 294 beams in M=100 ms that include m=5 samples for each index. The label data is thus a 294×5 matrix of (Pₜ₊₁, . . . . P_{t+M}).

A time series prediction model may be implemented to learn dependencies of historical RSRP plus each beam index (Qₜ₋₁, . . . , Q_{t-N}) over future RSRP values (Pₜ₊₁, . . . . P_{t+M}). LSTM may provide an effective approach to tackle a long-range dependencies problem, which is used in the model design in FIG. 9. The present model comprises a set of parameters θ_{(i,j)}, associated with each input Qᵢ. The earlier θ_{(i,-)} may be multiplied with a weight and added to the later one, to capture the time series dependencies. The output layer θ_{(·,l)} may be associated with each label Pᵢ. A loss function may be defined to evaluate the error between the model predicted P and detected P, for example:

$$e ( \hat{P} , P ) = \frac{1}{k} {\sum }_{i = 1}^{k} {( {J}_{i} ( \hat{P} \vert Q , θ ) - {P}_{i} )}^{2} .$$

In the training process, optimization algorithm like Stochastic Gradient Descend (SGD) can be applied to tune each θ_{(i,j)}, such that the average prediction error of samples collected from the UE can be minimized. The model reliability evaluation and assessment may be conducted when training steps are completed.

FIG. 10 illustrates an example of a timeline of model assessment and window prediction features, according to an example embodiment. Based on the above description, a ML sequence prediction model may be designed to collect input samples from past N ms and output window prediction samples up to future M ms.

At time instance t 1000, a UE 102 may host a trained ML model and enter a model assessment period, i.e., an evaluation window 1006, before the inference. The input data may be collected from the period 1004 of past N ms, i.e., t−N.

The evaluation window 1006 may last Lₑᵥₐₗ ms. It may be assumed the evaluation window 1006 equals to prediction window 1008 length for simplicity, i.e., Lₑᵥₐₗ=M ms. Therefore, whether the model assessment will be qualified or not may be indicated at the time instance t+Lₑᵥₐₗ ms 1002.

If the model assessment qualified, i.e., the ML model may be fully trusted, the UE may be configured to perform the window prediction. For a current time instance t+Lₑᵥₐₗ 1002, the prediction samples can be generated in a future window up to t+Lₑᵥₐₗ+M ms. However, the new input data may be collected from the period t+Lₑᵥₐₗ−N ms to t+Lₑᵥₐₗ ms. In case the model assessment was not qualified, the UE may be configured to perform a fallback solution, such as one or more legacy procedures.

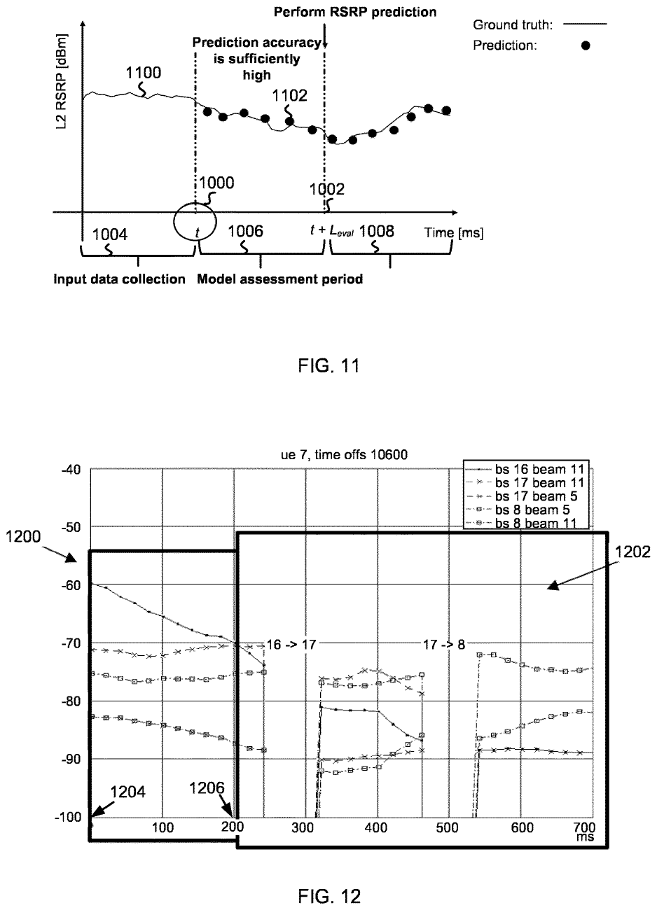

FIG. 11 illustrates an example of RSRP prediction from a single beam or cell, according to an example embodiment. In FIG. 11, at a time step t 1000, a candidate UE may have received a model assessment configuration message from a gNB and perform the model reliability assessment.

The configuration message from gNB may include at least one of: 1) the evaluation window 1006 length Lₑᵥₐₗ (assume Lₑᵥₐₗ=M ms for simplicity), 2) at least one of the selected evaluation function, criteria, thresholds, etc., from evaluation function and criteria related information (assume prediction accuracy is used), 3) a qualification acceptance threshold Yth.

As discussed above in the model structure of FIG. 9, the input data for the ML model to use at time step t 1000 may be (Qₜ₋₁, . . . , Q_{t-N}) (collected at 1004) and the ground truth 1100 in this time window [t, t+Lₑᵥₐₗ] may be (Pₜ₊₁, . . . . P_{t+M}) that accounts for the verification data set.

The UE may be configured to perform the ML model reliability evaluation and assessment operations within the time window [t, t+Lₑᵥₐₗ]. The prediction output 1102 from current evaluation window 1006 may be (Pₜ₊₁, . . . . P_{t+M}). A prediction accuracy ƒ_{E} may be computed by the UE per sample per time step and averaged across all the samples.

Assuming 1 bit indication (0/1) is used to represent the outcome of model reliability assessment. The UE may be configured to compare the computed average prediction accuracy ƒ_{E} against the qualification acceptance threshold γₜₕ.

The UE may be configured to generate 1 to the gNB, indicating the model reliability assessment passed based on the comparison. The gNB may be configured to send the outcome feedback ACK to the UE by fully trust the model prediction. In addition, the legacy handover and mobility procedure may be suspended by the gNB such that the ML based mobility procedure is fully granted to the UE.

The evaluation window may be terminated at the time step t+Lₑᵥₐₗ 1002, and the UE may be configured to perform the window prediction at 1008. As depicted in the previous section with reference to FIG. 9 and FIG. 10, the predicted RSRP samples in the future window may be generated up to t+Lₑᵥₐₗ+M ms.

FIG. 12 illustrates an example of a system-level simulation demonstrating feasibility of prediction window in handover decision making. At time step 0 (at 1204), the ML model reliability assessment within an evaluation window 1200 is started until a time step 200 ms at 1206 is met and the assessment is qualified successfully. Thus, at the time step 200 ms at 1206, UE performs the prediction within the prediction window 1202 [200 ms, 700 ms]. It is indicated that there are consecutive handovers happened from BS16 to BS17 and from BS17 to BS8 within a very short time window according to a legacy mobility procedure, which is detected as unnecessary handovers. Therefore, with the prediction outcome, a proactive handover will be executed from BS16 to BS8 directly so that unnecessary handover can be avoided.

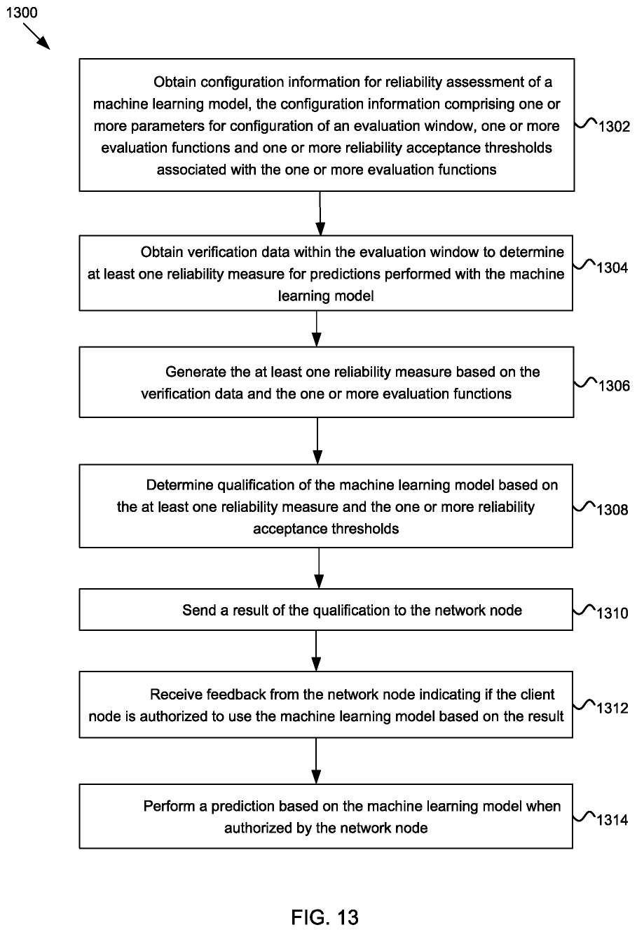

FIG. 13 illustrates an example of a method 1300 carried out by a client node for reliability assessment of a machine learning model, according to an example embodiment.

At 1302, the method may comprise obtaining configuration information for reliability assessment of a machine learning model, the configuration information comprising one or more parameters for configuration of an evaluation window, one or more evaluation functions and one or more reliability acceptance thresholds. The configuration information may be received, for example, from a network node.

At 1304, the method may comprise obtaining verification data within the evaluation window for determining at least one reliability measure for predictions performed with the machine learning model.

At 1306, the method may comprise generating the at least one reliability measure based on the verification data and the one or more evaluation functions.

At 1308, the method may comprise determining qualification of the machine learning model based on the at least one reliability measure and the one or more reliability acceptance thresholds.

At 1310, the method may comprise sending a result of the qualification to the network node.

At 1312, the method may comprise receiving feedback from the network node indicating if the client node is authorized to use the machine learning model based on the result.

At 1314, the method may comprise performing a prediction based on the machine learning model when authorized by the network node. For example, the client node may be configured to predict one or more target variables to be reported to the network node. The target variables may be related to mobility management. Alternatively, the prediction may not be related to mobility but some operation of the client node.

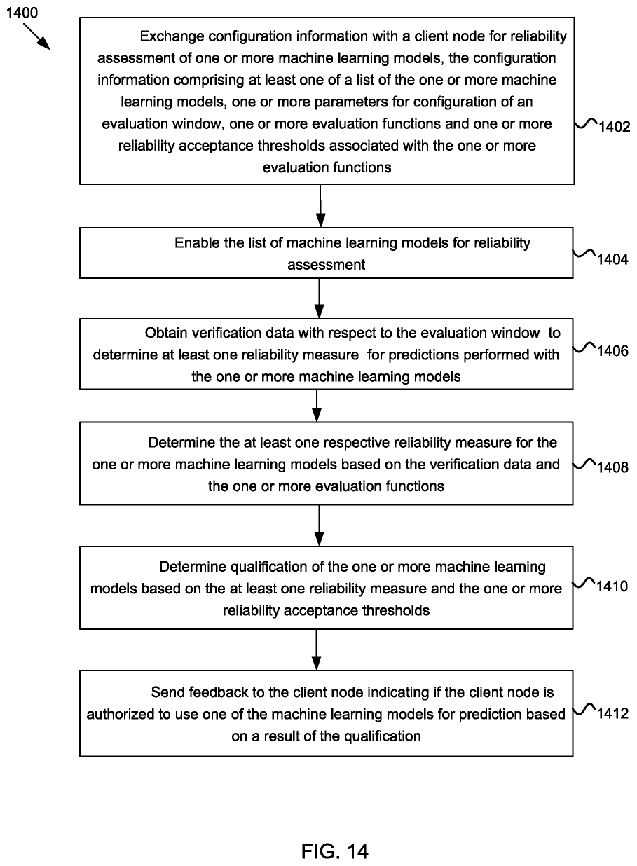

FIG. 14 illustrates an example of a method 1400 carried out by a network node for reliability assessment of a machine learning model.

At 1402, the method may comprise exchanging configuration information with a client node for reliability assessment of one or more machine learning models, the configuration information comprising at least one of a list of the one or more machine learning models, one or more parameters for configuration of an evaluation window, one or more evaluation functions and one or more reliability acceptance threshold.

At 1404, the method may comprise enabling the list of machine learning models for reliability assessment.

At 1406, the method may comprise obtaining verification data with respect to the evaluation window for determining at least one reliability measure for predictions performed with the one or more machine learning models. In an embodiment, the network node may be configured to request at least ground truth related verification data from the client node.

At 1408, the method may comprise determining the at least one respective reliability measure for the one or more machine learning models based on the verification data and the one or more evaluation functions.

At 1410, the method may comprise determining qualification of the one or more machine learning models based on the at least one respective reliability measure and the one or more reliability acceptance thresholds.

At 1412, the method may comprise sending feedback to the client node indicating if the client node is authorized to use one of the machine learning models for mobility management related prediction based on a result of the qualification.

Further features of the methods directly result from the functionalities and parameters of the apparatuses, as described in the appended claims and throughout the specification and are therefore not repeated here. It is noted that one or more operations of the method may be performed in different order.

An apparatus, for example a network node, a user node or a client node, may be configured to perform or cause performance of any aspect of the method(s) described herein. Further, computer program may comprise instructions for causing, when executed, an apparatus to perform any aspect of the method(s) described herein. Further, an apparatus may comprise means for performing any aspect of the method(s) described herein. According to an example embodiment, the means comprises at least one processor, and memory including program code, the at one memory and the program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A client node, comprising:
at least one processor; and
at least one memory comprising instructions which, when executed by the at least one processor, cause the client node at least to:
obtain configuration information for reliability assessment of a machine learning model, the configuration information comprising one or more parameters for configuration of an evaluation window, one or more evaluation functions and one or more reliability acceptance thresholds associated with the one or more evaluation functions;
obtain verification data within the evaluation window to determine at least one reliability measure for predictions performed with the machine learning model;
generate the at least one reliability measure based on the verification data and the one or more evaluation functions;
determine qualification of the machine learning model based on the at least one reliability measure and the one or more reliability acceptance thresholds;
send a result of the qualification to a network node;
receive feedback from the network node indicating if the client node is authorized to use the machine learning model based on the result; and
perform a prediction based on the machine learning model when authorized by the network node.

2. The client node of claim 1, wherein the one or more parameters comprise at least one of a start time of the evaluation window, an end time of the evaluation window, a duration of the evaluation window or an indication of a trigger configured to start the evaluation window.

3. The client node of claim 2, wherein the trigger comprises at least one of a change in measurement related to radio environment of the client node, a change in mobility profile of the client node, a handover and mobility related event trigger, a geo-location of the client node, or a periodic trigger detected by the client node or indicated by the network node.

4. The client node of claim 1, wherein the result sent to the network node is indicated with bit information, wherein one bit is used to indicate respective qualification result of comparison of the at least one reliability measure and associated reliability acceptance threshold.

5. The client node of claim 1, wherein the one or more evaluation functions are configured for calculation of at least one of prediction accuracy, mean square error, mean squared logarithmic error, mean absolute percentage error, mean confidence value, negative log likelihood or expected calibration error.

6. The client node of claim 1, wherein the feedback further comprises instructions to at least one of request for machine learning model update, discard the machine learning model for predicting measurements to be reported, perform the measurements to be reported with a non-machine learning based method, or perform re-assessment of the reliability.

7. The client node of claim 1, wherein the at least one memory comprises instructions which, when executed by the at least one processor, cause the client node to:
cause historical data of operations to be stored at the client node or the network node with an indication of a higher reliability measure when performed after use of the machine learning model is authorized and with an indication of a lower reliability measure when performed after use of the machine learning model is not authorized; and
perform re-training of the machine learning model based on the historical data stored at the client node or receive an update of the machine learning model re-trained based on the historical data stored at the network node.

8. A network node, comprising:
at least one processor; and
at least one memory including instructions which, when executed by the at least one processor, cause the network node at least to:
exchange configuration information with a client node for reliability assessment of one or more machine learning models, the configuration information comprising at least one of a list of the one or more machine learning models, one or more parameters for configuration of an evaluation window, one or more evaluation functions and one or more reliability acceptance thresholds associated with the one or more evaluation functions;
enable the list of machine learning models for reliability assessment;
obtain verification data within the evaluation window to determine at least one reliability measure for predictions performed with the one or more machine learning models;
determine the at least one respective reliability measure for the one or more machine learning models based on the verification data and the one or more evaluation functions;
determine qualification of the one or more machine learning models based on the at least one respective reliability measure and the one or more reliability acceptance thresholds; and
send feedback to the client node indicating if the client node is authorized to use one of the machine learning models for prediction based on a result of the qualification.

9. The network node of claim 8, wherein the at least one memory further comprises instructions which, when executed by the at least one processor, cause the network node to:
send a request for the verification data within the evaluation window to the client node; and
receive the verification data from the client node.

10. The network node of claim 8, wherein the one or more parameters comprise at least one of a start time of the evaluation window, an end time of the evaluation window, a duration of the evaluation window or an indication of a trigger to start the evaluation window.

11. The network node of claim 8, wherein the one or more evaluation functions are configured for calculation of at least one of prediction accuracy, mean square error, mean squared logarithmic error, mean absolute percentage error, mean confidence value, negative log likelihood or expected calibration error.

12. The network node of claim 8, wherein the feedback further comprises an identifier of the machine learning model authorized for performing measurements to be reported, instructions for repeating the reliability assessment, instructions for performing the measurements to be reported with a non-machine learning based method or instructions to request for a machine learning model update.

13. The network node of of claim 8, wherein the at least one memory comprises instructions which, when executed by the at least one processor, cause the network node to:
store historical data of operations performed by the client node with an indication of a higher reliability measure when performed after use of the machine learning model is authorized and with an indication of a lower reliability measure when performed after use of a machine learning model is not authorized; and
perform re-training of the one or more machine learning models based on the stored historical data.

14. A method carried out by a client node, comprising:
obtaining configuration information for reliability assessment of a machine learning model, the configuration information comprising one or more parameters for configuration of an evaluation window, one or more evaluation functions and one or more reliability acceptance thresholds associated with the one or more evaluation functions;
receiving the configuration information from a network node;
obtaining verification data within the evaluation window to determine at least one reliability measure for predictions performed with the machine learning model;
generating the at least one reliability measure based on the verification data and the one or more evaluation functions;
determining qualification of the machine learning model based on the at least one reliability measure and the one or more reliability acceptance thresholds;
sending a result of the qualification to the network node;
receiving feedback from the network node indicating if the client node is authorized to use the machine learning model based on the result; and
performing a prediction based on the machine learning model when authorized by the network node.

15. A method carried out by a network node, comprising:
exchanging configuration information with a client node for reliability assessment of one or more machine learning models, the configuration information comprising at least one of a list of the one or more machine learning models, one or more parameters for configuration of an evaluation window, one or more evaluation functions and one or more reliability acceptance thresholds associated with the one or more evaluation functions;
enabling the list of machine learning models for reliability assessment;
obtaining verification data to determine at least one reliability measure for predictions performed with the one or more machine learning models;
determining the at least one respective reliability measure for the one or more machine learning models based on the one or more evaluation functions;
determining qualification of the one or more machine learning models based on the at least one respective reliability measure and the one or more reliability acceptance thresholds; and
sending feedback to the client node indicating if the client node is authorized to use one of the machine learning models for prediction based on a result of the qualification.
